(19) United States
(12) Patent Application Publication
(10) Pub. No.: US 2014/0315636 A1
(43) Pub. Date: Oct. 23, 2014

(54) METHOD FOR ENABLING USAGE OF A COMPUTERIZED MOBILE DEVICE AS A GAME GRAPHICAL USER INTERFACE FOR AN APPLICATION GAME

(71) Applicant: SCREENOVATE TECHNOLOGIES LTD., Ra'anana (IL)

(72) Inventors: Tal ZARFATI, Nordiya (IL); Matan SHAPIRA, Tel Aviv (IL)

(21) Appl. No.: 14/255,263

(22) Filed: Apr. 17, 2014

Related U.S. Application Data
(60) Provisional application No. 61/813,240, filed on Apr. 18, 2013.

(51) Int. Cl. A63F 13/20

(52) U.S. Cl. CPC A63F 13/06
USPC 463/31; 463/37

(57) ABSTRACT

A method for enabling usage of a Computerized mobile device as an external controller device for playing an application game is provided herein. The method comprises the following steps: (i) selecting a controller layout for a game application, wherein said controller layout includes the same game functionalities of an interface of the external controller, and wherein each key in the interface of the external controller device has an equivalent controlling element in the controller layout having the same functionality; (ii) running the controller layout on the Computerized mobile device; (iii) running a game application on a Computerized mobile device; (iv) displaying the game application throughout the game session on an external screen; (v) receiving instructions related to the game application from a user via the controller layout on the Computerized mobile device; and (vi) virtualizing the received instructions of the game application to perform an action in the game application.

### TECHNICAL FIELD

The present invention relates to the field of game applications, and more particularly, to playing with a controller layout for an external controller device that is used to interact with an application game that is running on a computerized mobile device and playing the application game with the controller layout.

### BACKGROUND ART

There are many console games in the market which have a dedicated device, i.e. game GUI device, such as Wii© and Xbox©. Many Computerized mobile device owners would like use their Computerized mobile device as a game GUI device for these games. Currently, this option of using a Computerized mobile device for playing games that were designed for console game is not possible.

### SUMMARY OF INVENTION

The present disclose a method for enabling usage of a computerized mobile device as an external controller device for playing an application game. The method comprising the steps of: selecting a controller layout for a given game application, wherein said controller layout includes same game functionalities of an interface of an external controller device compatible with the given game application and at least one key in the interface of the external controller device has an equivalent controlling element in the controller layout having the same functionality, running the controller layout on the computerized mobile device;

running a game application, receiving instructions related to the game application from a user via the controller layout on the computerized mobile device, wherein the received instructions include identification of the activated controlling elements in the controller layout and virtualizing the received instructions of the game application to perform an action in the game application, wherein said action is determined according to the functionality of the identified activated controlling element which correspond with equivalent key of the of the external controller.

According to some embodiments the controller layout is prepared by applying the following steps:

According to some embodiments the method further comprising the steps of receiving specifications and a programmatic code of a requested application game and details of the related external controller layout device, identifying as the related external controller device of the computerized mobile device for the requested application game, simulating the operation of the external controller layout device by sending instructions to the requested game application according to the received specifications and the programmatic code, receiving response to the instructions and analyzing it, testing each function in the application game and each key in the related external controller layout device and generating design of the layout of the controller layout, the functionality of the keys and motion of the computerized mobile device which imitate the external game controller layout device operation.

According to some embodiments the controller layout is prepared by operating a wizard to manually create the controller layout by a user;

According to some embodiments the controller layout is a default controller layout most compatible to the given game.

According to some embodiments the method further comprising the step of providing the user with an option to adjust keys in the controller layout.

According to some embodiments wherein the game is displayed on an external screen;

According to some embodiments the control layout can be manually adjusted by apply at least on of the following operations: determining layout settings of the keys in the controller layout, determining the functionality of specific keys and/or defining the motion of the Computerized mobile device as an instruction to the game application.

According to some embodiments the game application is activated on the computerized mobile device.

According to some embodiments the game application is activated on the external device associated with the mobile device.

According to some embodiments the external device is a receiver module associated with the an external screen on which the game is displayed.

The present invention discloses a system for enabling usage of a computerized mobile device as an external controller device for playing an application game. The system comprised of: Interface module which enables to select a controller layout for a given game application, wherein said controller layout includes same game functionalities of an interface of an external controller device compatible with the given game application, wherein at least one key in the interface of the external controller device has an equivalent controlling element in the controller layout having the same functionality, an interface of game application for running the controller layout on the computerized mobile device, running a game application, receiving instructions related to the game application from a user via the controller layout on the computerized mobile device, wherein the received instructions include identification of the activated controlling elements in the controller layout and virtualizing the received instructions of the game application to perform an action in the game application, wherein said action is determined according to the functionality of the identified activated controlling element which correspond with equivalent key of the of the external controller.

These, additional, and/or other aspects and/or advantages of the present invention are: set forth in the detailed description which follows; possibly inferable from the detailed description; and/or learnable by practice of the present invention.

### BRIEF DESCRIPTION OF DRAWINGS

FIG. 1 is a block diagram of a computerized mobile device that is running an application which simulates a graphical user interface for an application game, according to some embodiments of the invention;

FIG. 1A is a block diagram of a computerized mobile device that is running an application which simulates a graphical user interface for an application game running on a receiver modules, according to some embodiments of the invention;

FIG. 2 is a flowchart diagram illustrating a method of building a controller layout for an application game, according to some embodiments of the invention;

FIG. 3 is a flowchart diagram illustrating a method of playing using a controller layout that is running on a computerized mobile device for an application game, according to some embodiments of the invention; and

FIG. 4 is a flowchart diagram illustrating a method of building a controller layout for a game that is running on a computerized mobile device utilizing a wizard, according to some embodiments of the invention.

### MODES FOR CARRYING OUT THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The term “computerized mobile device” as used herein in this application, is defined as a device such as Smartphone or tablets.

The term “controller layout” as used herein in this application, is defined as an interface that is running on a computerized mobile device and allows a user to control a process of an application game that is presented on an external screen.

The term “game controller layout device” as used herein in this application, is defined as an external input device that which controls application games that has a controller layout. For example, a joystick. The interface of the game controller layout device may be referred to an external controller.

The term “receiver module” as used herein in this application, is defined as a processing communication module embedded in a dongle device or integrated in external screen such as TV or monitor device which support managing activating and streaming multimedia application.

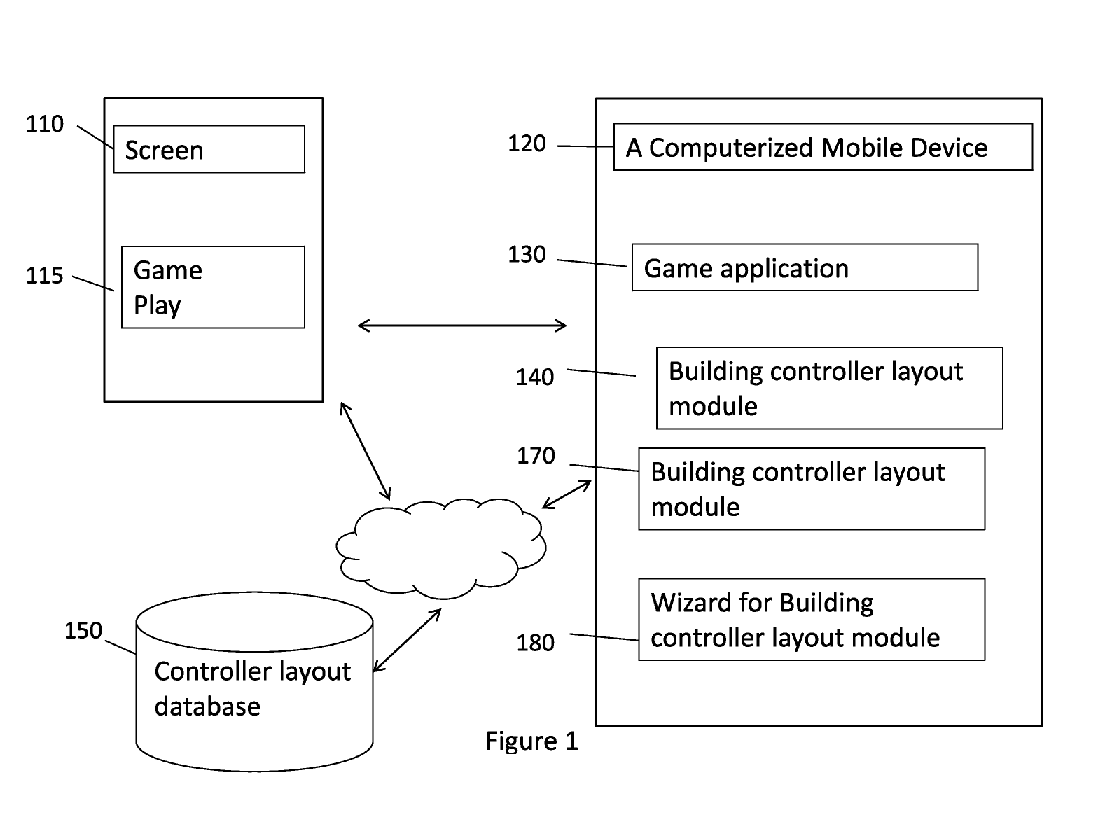

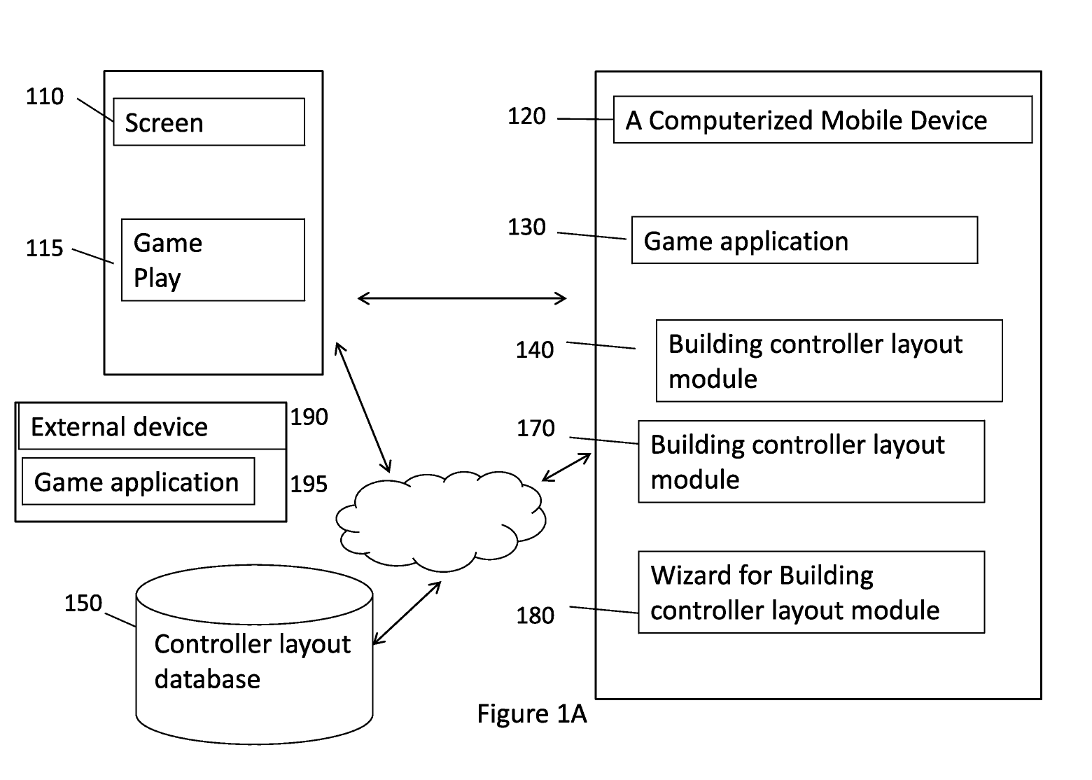

FIG. 1 is a block diagram of a computerized mobile device that is running an application which simulates a graphical user interface for an application game, according to some embodiments of the invention.

According to some embodiments of the present invention, a gamer of an application game would like to use a Computerized mobile device 120 as a game controller layout device for a game that is running on the Computerized mobile device 120 and displayed throughout the game session on a target screen. For that purpose, the gamer may start a game application 130 and project it on an external screen 110 on an area on the screen 115. In a non-limiting example, the game application 130 may be Pac-Man©. In this game an object is moving forward in an illustrated maze trying to escape ghosts. The object may move forwards, backwards and jump over obstacles. Commonly, in order to play this game a game controller layout device is needed to control the motion and to move of the object.

According to some embodiments of the present invention, the Pac-Man© game may be controlled by the Computerized mobile device 120. The Computerized mobile device may imitate the operation of a game controller layout device and control the process of the game via an interface of game application 140.

According to some embodiments of the present invention for each game application 140 may be associated a designated controller layout which is designed to imitate the operation of an external controller device which is related and is compatible to the game application. For each game external controller device several templates may be made and stored in a database 150, where each template may be compatible for a type of game. The controller layout may be retrieved from a database 160 that is located on the Computerized mobile device 120 or a remote database 150 that is located in the cloud.

Furthermore, the controller layout may be adjusted manually by the gamer. A wizard 180 may be utilized for the manual adjustment. The adjustment may include: (i) layout settings of the keys in the controller layout, such as position and color; (ii) functionality of the keys; and (iii) motion of the Computerized mobile device as an instruction to the game application 130.

The building controller layout module 170 enables to create new controller layout templates for new types of application games or new controller layout devices. This module may be located on the Computerized mobile device or on the cloud 180.

A designer of controller layout may utilize a wizard to operate building controller layout module 170 or 180 to determine the function of the keys in the simulated game controller layout device (i.e. interface of game application 140), the layout of the interface of the game application 140 and motion of the Computerized mobile device as an instruction to the game application 130.

According to some embodiments of the present invention, the new controller layout that was built, by utilizing a wizard may be saved in the local database 160 or remote database 150.

According to some embodiments of the invention, the controller layout includes the at least part of the same game functionalities of an interface of the external controller which is compatible with the requested game.

According to some embodiments of the invention, at least one key in the interface of the external controller device has an equivalent controlling element in the controller layout having the same functionality.

According to some embodiments of the invention a game runs on external device 190 such as tablet, set-top box, dongle or smart TV. The external device is connected to the mobile device via direct or indirect wired or wireless connection.

The controller layout may be created on the mobile device may be created on the external device and streamed to the mobile device.

FIG. 1A is a block diagram of a computerized mobile device that is running an application which simulates a graphical user interface for an application game running on a receiver modules, according to some embodiments of the invention;

According to some embodiments of the present invention the external screen is associated with a receiver module 190 which serves as the external device. In such embodiments the source of the game application 195 may be activated from the receiver module and the and not from computerized mobile device.

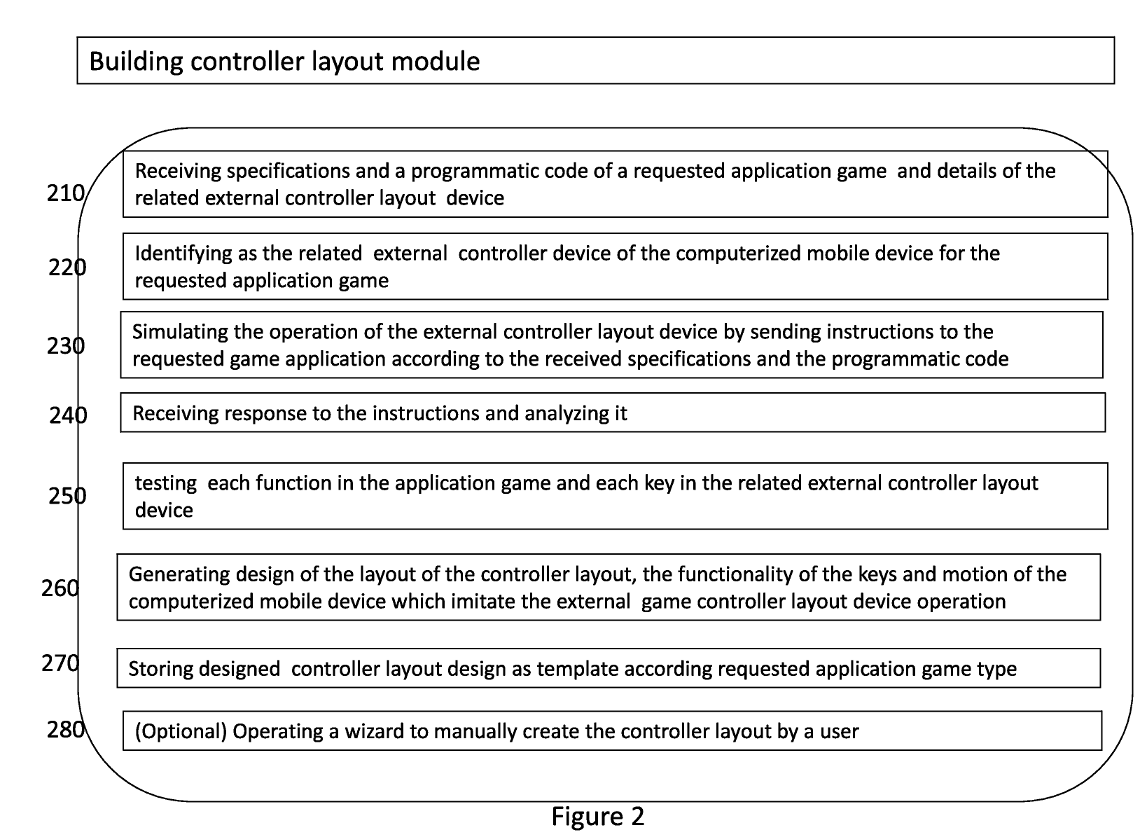

FIG. 2 is a flowchart illustrating a method of building a controller layout for an application game, according to some embodiments of the invention.

In a non-limiting example, an application game, Pac-Man may run on a Computerized mobile device and may be projected on a remote/external screen. In case there is no specific controller layout or template controller layout for the application game in a local database of controller layout or in a remote database of controller layout that is located in the cloud, building controller layout module 170 in FIG. 1 may be operated.

According to some embodiments of the present invention, building controller layout module 170 or 180 in FIG. 1 may receive specifications of the related external controller device and a programmatic code of a requested application game including the game type (stage 210).

According to the example, the specifications of Pac-Man© may include an object, which is the protagonist of the game and may also include its movement options: forward, backward and jump. Next, the building controller layout module 170 or 180 may identify as a controller layout of the application game of an external controller device of the Computerized mobile device (stage 220) simulating the related controller layout device operation/activity and as such, start sending instructions via the controller layout to the game application according to the received specifications and the programmatic code (stage 230). In a non-limiting example, the instructions may be ‘go forward’, ‘go backwards’ or jump.

According to some embodiments of the present invention, the building controller layout module 170 or 180 may receive response to the instructions (stage 240) and may use it to infer, by testing each function in the application game and each key in the related external controller layout device computerized mobile device (stage 250). The analysis of the response that may be received from the game application, may be the object's movement and direction (i.e. left, right or up).

According to some embodiments of the present invention, the building module generates the design of the layout of the controller layout, the functionality of the keys and motion of the Computerized mobile device imitating the related controller layout device operation (stage 260). In a non-limiting example, tilting the Computerized mobile device to the right may function as a right movement of the object in the application game using the controller layout device, tilting the Computerized mobile device to the left may be left movement of the object in the application game and rising the Computerized mobile device up may be to command the object in the application game to jump.

Once the design of the controller layout is completed it is save as template for the game type which was simulated and or as a controller layout of the specific application game (stage 270).

According to some embodiments of the present invention, optionally, building controller layout module 170 or 180 may operate a wizard to manually create the controller layout by a designer of controller layout (stage 280).

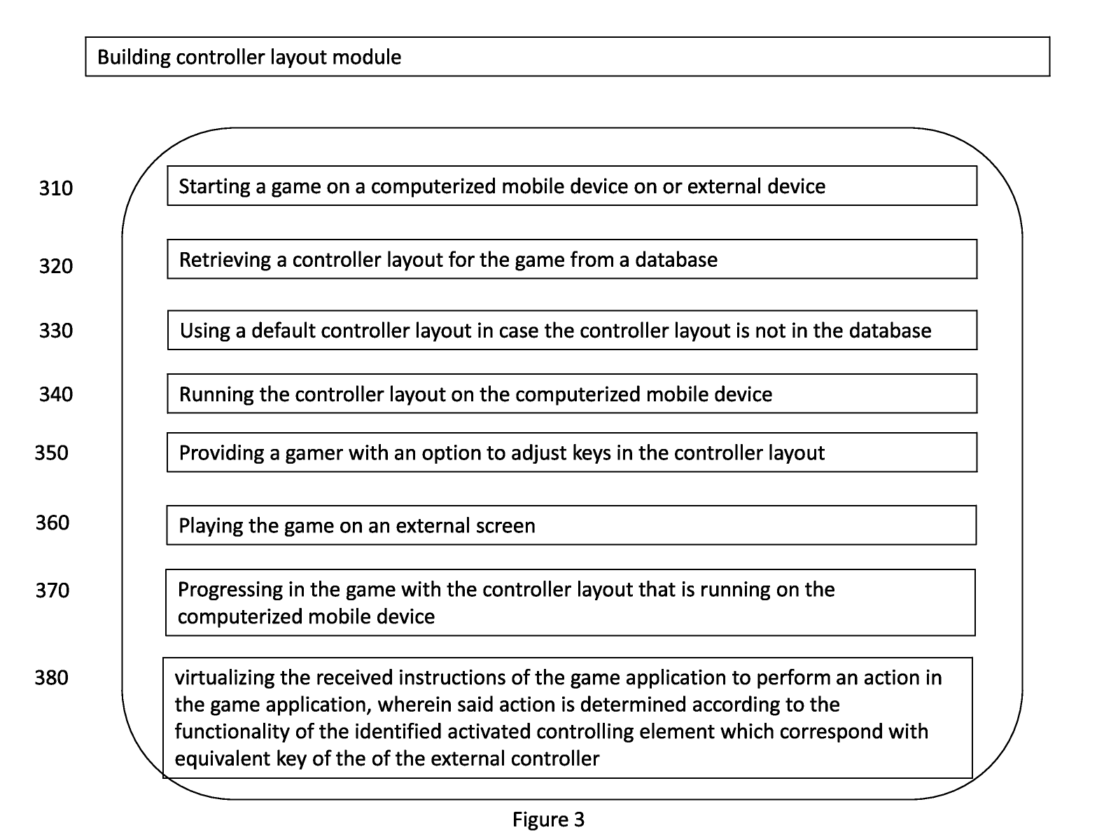

FIG. 3 is a flowchart illustrating a method of playing using a controller layout that is running on a computerized mobile device for an application game, according to some embodiments of the invention.

In a non-limiting example, a gamer may run an application game on a Computerized mobile device which may project the application game on a remote/external screen. In case the application game is a game such as Pac-Man© which requires a game controller layout device according to some embodiments of the present invention, the Computerized mobile device may operate as such.

According to some embodiments of the present invention, the gamer may start the application game on the Computerized mobile device (stage 310) or external device such as tablet, set-top box, dongle or smart TV. After the application game is loaded and before starting the game, an interface of game application may retrieve a controller layout or controller layout template for the application game from a database (stage 320). The database of controller layout may be located on the Computerized mobile device or located remotely/externally on the cloud. In case, the interface of game application didn't find a controller layout for the application game in the database it may use a default controller layout, wherein said controller layout includes the same game functionalities of an interface of the external controller (stage 330). The created controller layout may be operated on the computerized mobile device (stage 340).

According to some embodiments of the present invention, once the interface of game application has a controller layout for the application game the gamer may be provided with an option to adjust keys in the controller layout (stage 350).

The game may be displayed throughout the game session on an external screen (stage 360).

According to some embodiments of the present invention, the gamer may progress in the application game with the controller layout by virtualizing the received instructions of the game application to perform an action in the game application (stage 370, 380).

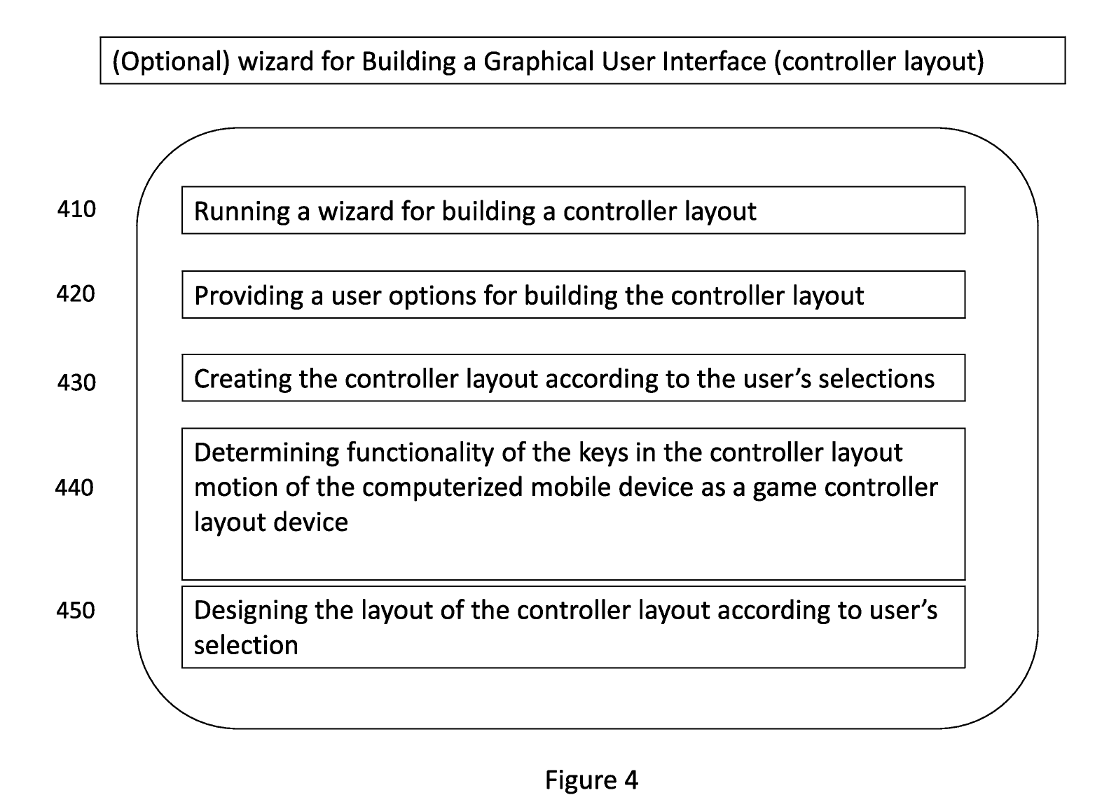

FIG. 4 is a flowchart illustrating a method of building a controller layout for a game that is running on a computerized mobile device utilizing a wizard, according to some embodiments of the invention.

According to some embodiments of the present invention, a designer may create a controller layout by utilizing a wizard. The design may begin by running the wizard for building a controller layout (stage 410). The wizard may provide the designer options for building the controller layout (stage 420). The controller layout may be created according to the designer's selections (stage 430).

According to some embodiments of the present invention, the designer may determine the functionality of keys in the controller layout (stage 440). Meaning, for example, which key may instruct an object in the application game to go right and which key or tilt side may instruct an object to go left.

According to some embodiments of the present invention, the designer may determine the layout of the controller layout (stage 450).

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

What is claimed is:

1. A method for enabling usage of a computerized mobile device as an external controller device for playing an application game , the method comprising the steps of:
selecting a controller layout for a given game application,
wherein said controller layout includes same game functionalities of an interface of an external controller device compatible with the given game application,
wherein at least one key in the interface of the external controller device has an equivalent controlling element in the controller layout having the same functionality;
running the controller layout on the computerized mobile device;
running a game application;
receiving instructions related to the game application from a user via the controller layout on the computerized mobile device,
wherein the received instructions include identification of the activated controlling elements in the controller layout; and
virtualizing the received instructions of the game application to perform an action in the game application, wherein said action is determined according to the functionality of the identified activated controlling element which correspond with equivalent key of the of the external controller.

2. The method of claim 1 wherein the controller layout is prepared by applying the following steps:
receiving specifications and a programmatic code of a requested application game and details of the related external controller layout device;
identifying as the related external controller device of the computerized mobile device for the requested application game;
simulating the operation of the external controller layout device by sending instructions to the requested game application according to the received specifications and the programmatic code;
receiving response to the instructions and analyzing it;
testing each function in the application game and each key in the related external controller layout device; and
generating design of the layout of the controller layout, the functionality of the keys and motion of the computerized mobile device which imitate the external game controller layout device operation.

3. The method of claim 1 wherein the controller layout is prepared by operating a wizard to manually create the controller layout by a user;

4. The method of claim 1 wherein the controller layout is a default controller layout most compatible to the given game.

5. The method of claim 1 further comprising the step of providing the user with an option to adjust keys in the controller layout.

6. The method of claim 1 wherein the game is displayed on an external screen;

7. The method of claim 1 wherein the control layout can be manually adjusted by apply at least on of the following operations: determining layout settings of the keys in the controller layout, determining the functionality of specific keys and/or defining the motion of the Computerized mobile device as an instruction to the game application.

8. The method of claim 1 wherein the game application is activated on the computerized mobile device.

9. The method of claim 1 wherein the game application is activated on the external device associated with the mobile device.

10. The method of claim 1 wherein the external device is a receiver module associated with the an external screen on which the game is displayed.

11. A system for enabling usage of a computerized mobile device as an external controller device for playing an application game, the system comprised of:
Interface module which enables to select a controller layout for a given game application, wherein said controller layout includes same game functionalities of an interface of an external controller device compatible with the given game application, wherein at least one key in the interface of the external controller device has an equivalent controlling element in the controller layout having the same functionality; and
an interface of game application for running the controller layout on the computerized mobile device, running a game application, receiving instructions related to the game application from a user via the controller layout on the computerized mobile device, wherein the received instructions include identification of the activated controlling elements in the controller layout and virtualizing the received instructions of the game application to perform an action in the game application, wherein said action is determined according to the functionality of the identified activated controlling element which correspond with equivalent key of the of the external controller.

12. The system of claim 10, further comprising Building controller layout module, said module applying the following steps:
receiving specifications and a programmatic code of a requested application game and details of the related external controller layout device;
identifying as the related external controller device of the computerized mobile device for the requested application game;
simulating the operation of the external controller layout device by sending instructions to the requested game application according to the received specifications and the programmatic code;
receiving response to the instructions and analyzing it;
testing each function in the application game and each key in the related external controller layout device; and
generating design of the layout of the controller layout, the functionality of the keys and motion of the computerized mobile device which imitate the external game controller layout device operation.

13. The system of claim 10 further comprising a wizard for create the controller layout manually by a user.

14. The system of claim 10 wherein the controller layout is a default controller layout most compatible to the given game.

15. The system of claim 10 further comprising a wizard for providing the user with an option to adjust keys in the controller layout.

16. The system of claim 10 wherein the game is displayed on an external screen.

17. The system of claim 15 wherein the control layout can be manually adjusted by applying at least one of the following operations: determining layout settings of the keys in the controller layout, determining the functionality of specific keys and/or defining the motion of the computerized mobile device as an instruction to the game application.

18. The system of claim 10 wherein the game application is activated on the computerized mobile device.

19. The system of claim 10 wherein the game application is activated on the external device associated with the mobile device.

20. The system of claim 10 wherein the external device is a receiver module associated with the an external screen on which the game is displayed.
